(19) United States
(12) Patent Application Publication
(10) Pub. No.: US 2006/0048441 A1
(43) Pub. Date: Mar. 9, 2006

(54) Fishing apparatus

(76) Inventor: William R. Sharff, Springfield, PA (US)

Correspondence Address: ROBERT J. YARBROUGH, ATTORNEY AT LAW, 201 NORTH JACKSON STREET, MEDIA, PA, 19063, US

(21) Appl. No.: 10/935,203

(22) Filed: Sep. 7, 2004

(51) Int. Cl. A01K 97/06; A01K 97/00

(52) U.S. Cl. 43/54.1

(57) ABSTRACT

The Invention is a fishing apparatus for use with a fishing rod holder, such as a sand spike. A shelf body composed of closed-cell plastic foam defines an opening having a diameter less than the diameter of the cylindrical fishing rod holder. The opening is adapted to receive and to resiliently retain the shelf body on the cylindrical fishing rod holder. The shelf body may be readily configured by the user by cutting or puncturing the plastic foam.

### BACKGROUND OF THE INVENTION

1. Field of the Invention

The Invention relates generally to the sport of fishing and specifically to surf or other fishing using a fishing rod holder, such as a cylindrical sand spike. The Invention is a fishing accessory that allows a user conveniently to support bait, tackle and other gear while fishing.

2. Description of the Prior Art

In the prior art of surf fishing, a fisherman casts bait into the water from shore using spinning tackle. The spinning tackle comprises a baited hook, line, rod and reel. The fisherman may continually hold the handle of the rod in his or her hands, waiting for a fish to take the bait. Alternately, the fisherman may place the handle of the rod into a fishing rod holder.

A popular design for a fishing rod holder comprises a plastic tube. The inside diameter of the tube is large enough to accept the handle of the fishing rod. The plastic tube is secured in an upright position. By placing the handle of the rod into the plastic tube, the fishing rod is supported in an upright position and the fisherman is relieved from the obligation of manually holding the rod. The plastic tube fishing rod holder may be driven into the ground or may be secured to a land vehicle, a boat or an architectural feature, such as a railing.

A plastic tube adapted to be driven into the sand of a beach to hold a fishing rod is known as a “sand spike.” The use of sand spikes allows a fisherman to operate several fishing rods and associated tackle simultaneously. The use of a sand spike also allows the fisherman to engage in other activities while awaiting a fish. The sand spike is a convenient location for the fisherman to store his or her rod while baiting the hook or otherwise maintaining the tackle.

Providing a location on which a fisherman may bait a hook, store hooks and other tackle or perform other actions is desirable. Providing a shelf adapted to be readily modified by a user to suit the user's needs is desirable.

Sand spikes and associated apparatus have been addressed by the prior art:

U.S. Pat. No. 4,372,072 to Comeau issued Feb. 8, 1983 teaches a sand spike for surf fishing.

U.S. Pat. No. 4,293,113 to Gray issued Oct. 6, 1981 teaches a fishing rod holder that may be inserted into the sand by a sand spike or hung from a car or from a railing.

U.S. Pat. No. 3,344,551 to Chestnut issued Oct. 3, 1967 teaches a surf fishing rod holder having a sharpened stick for insertion in the ground.

U.S. Pat. No. 2,877,828 to Barnette issued Mar. 17, 1959 teaches a folding fisherman's stool and rod holder mounted on top of a support that is driven into the ground.

U.S. Pat. No. 1,654,876 to Hemming issued Apr. 3, 1926 teaches a fishing pole holder including a rod having a sharpened lower end to be driven into the ground.

None of the prior art patents discloses the features of the present Invention.

### SUMMARY OF THE INVENTION

The Invention is a movable and readily configurable attachment for use with a cylindrical fishing rod holder, such as a sand spike. The attachment may take the form of a shelf and is composed of a closed-cell foam. The shelf hence will float and will not significantly absorb water. The shelf defines an opening having a smaller inside diameter than the outside diameter of the sand spike. A depression to retain bait, tackle or other objects appears in the shelf.

The fisherman passes the sand spike through the opening. The deformation of the walls of the opening by the sand spike causes the resilient foam of the shelf to apply pressure to the sand spike, which retains the shelf in position on the sand spike. The fisherman may place the shelf in any desired location on the sand spike. Since a sand spike may be several feet long, a wide range of adjustment of the position of the shelf is possible.

The closed cell foam construction of the shelf allows the user to readily configure the shelf to meet the user's needs, as by cutting a slot to receive a knife or by cutting a hole for a flashlight. Fishing hooks and related tackle may be stored on the shelf by penetrating the surface of the shelf with the point of the hook and withdrawing the hook from the shelf when the hook is needed. The shelf may be penetrated repeatedly by hooks without significant degradation in the performance of the shelf. The hooks may be inserted into the opening created by previous penetrations.

### BRIEF DESCRIPTION OF THE DRAWINGS

FIG. 1 is a perspective view of the Invention installed on a sand spike.

FIG. 2 is a perspective view of the Invention.

FIG. 3 is a perspective view of the Invention.

FIG. 4 illustrates the Invention in use.

FIG. 5 is a perspective view of an alternative embodiment.

### DESCRIPTION OF AN EMBODIMENT

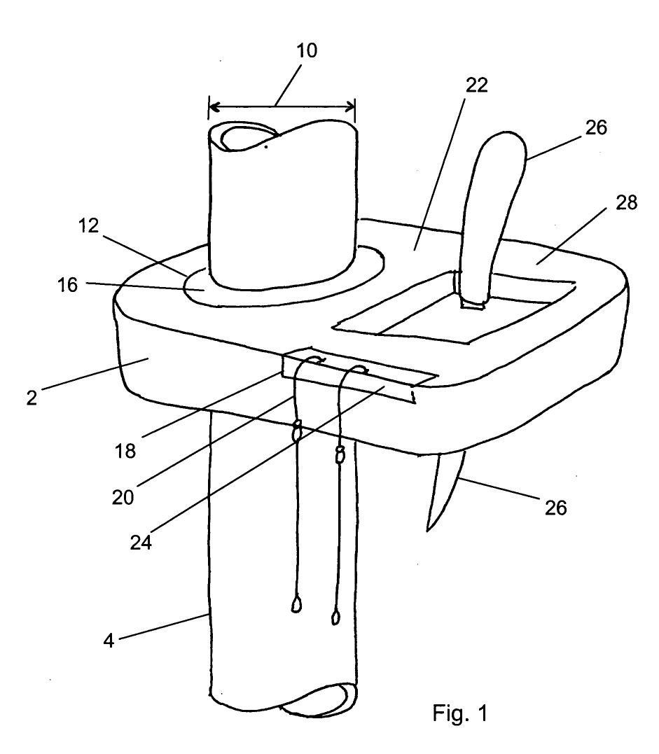

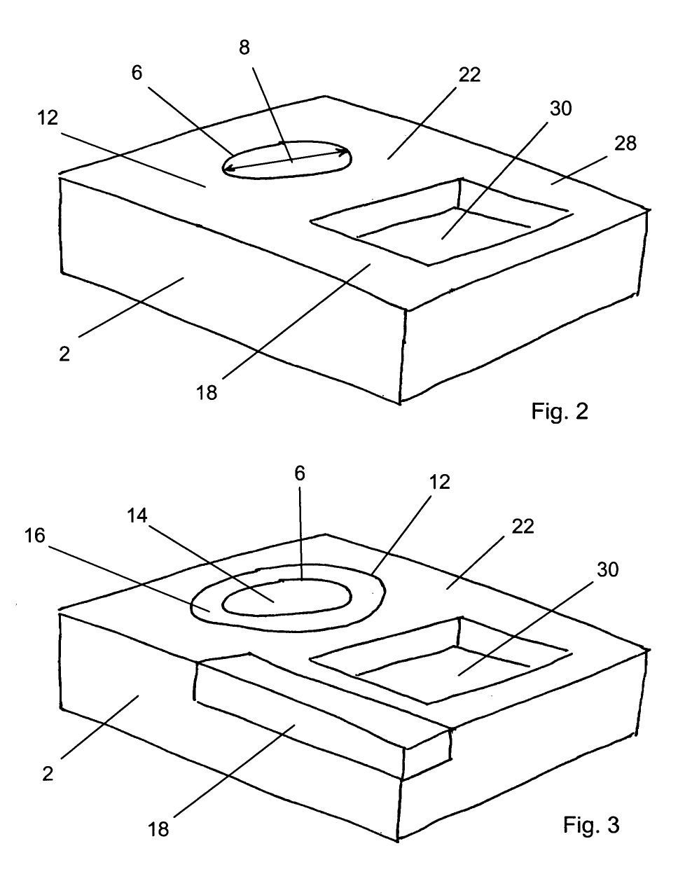

The Invention is a shelf 2 for use with a fishing rod holder 4, such as a sand spike. As shown by FIGS. 2 and 3, shelf 2 defines an opening 6 that has an inside diameter 8. Opening 6 penetrates through shelf 2. From FIG. 1, cylindrical fishing rod holder 4 has an outside diameter 10. Inside diameter 8 is selected to be less than outside diameter 10, so that cylindrical fishing rod holder 4 is an interference fit in opening 6.

Shelf 2 has a rod holder engaging portion 12 that defines a wall 14 of opening 6. Rod holder engaging portion 12 is composed of a rod holder engaging portion material 16. Rod holder engaging portion material 16 is selected to have a modulus of elasticity corresponding to a stiffness sufficient so that the elastic deformation of rod holder engaging portion material 16 caused by the interference fit between the cylindrical fishing rod holder 4 and rod holder engaging portion 12 results in shelf 2 releasably engaging rod holder 4 when shelf 2 is in place on rod holder 4.

As used in this application, the term “releasably engage” means that the shelf 2 may be manually installed and removed on and from the cylindrical fishing rod holder 4 and further that the shelf 2 may be manually moved from one position to another on the fishing rod holder 4, but that the shelf 2 will remain where placed on the fishing rod holder 4 and will support a load. As used in this application the term “modulus of elasticity” means a change in unit length of a material in response to a unit stress, and is a characteristic of the material. The term “stiffness” means the product of the modulus of elasticity of the material and the cross sectional area of the material normal to the applied stress.

The preferred rod holder engaging portion material 16 is a closed-cell plastic foam. Closed cell plastic foams are preferred for their durability, light weight and buoyancy in water. Plastic foam is available in a wide variety of densities and physical characteristics. Foams that are either too flexible or too rigid are not suitable. Flexible to Semi-rigid closed-cell foams composed of polypropylene or polyethylene are believed suitable for this application. Polylam® or PolyPlank® LAM laminated polyethylene foam available from Pactiv Corporation of 1900 West Field Court, Lake Forest, Ill. 60045, in 1.5 and 1.7 pound densities has proven suitable.

As shown by FIGS. 1 and 3, shelf 2 defines a hook-engaging portion 18. Hook engaging portion 18 releasably receives the point and barb of a hook 20. The point and barb of hook 20 penetrates hook engaging portion 18, storing hook 20 and avoiding accidental hook 20 wounds to the user. The hook engaging portion 18 may occupy any or all of the body 22 of shelf 2.

The hook engaging portion 18 is composed of a hook engaging portion material 24. The hook engaging portion material 24 is selected so that the user may readily penetrate the hook engaging portion 18 with hook 20 and so that hook engaging portion 18 will retain the hook 20. The hook engaging portion material 24 also is selected so that the hook engaging portion 18 will not trap the barb of hook 20 and prevent removal of hook 20. The hook engaging portion material 24 is selected so that the hole created by puncturing the hook engaging portion 18 with hook 20 is durable and may be used repeatedly to store hooks 20 without significant degradation of the hook engaging portion 18. The hook engaging portion material 24 is further selected so that the hook engaging portion 18 may be punctured repeatedly by hooks 20 without significant degradation to the hook engaging portion 18.

Closed cell plastic foam is a suitable hook engaging portion material 24. The closed cell plastic foam of the hook engaging portion 18 may be selected to be the same plastic foam selected for the rod holder engaging portion material 16, such as Polylam® or PolyPlank® LAM laminated polyethylene foam.

Shelf 2 has a shelf body 22. The shelf body 22 is adapted to be readily configured by the user. As used in this application, the term “readily configured” means that the user may cut or shape the shelf body 22 with hand tools to meet the needs of the user. In the example illustrated by FIG. 1, the shelf body 22 has been configured by a user to hold a knife 24. The user has configured the shelf body 22 by pressing the knife 26 through the shelf body 22, thereby cutting the shelf body 22 to create a knife-receiving slot. The user may similarly configure the body 22 in any other way desired by the user, such as pressing pliers through shelf body 22 to create a pliers-receiving opening or by cutting an opening to receive a flashlight.

The shelf body 22 is adapted to be “readily configured” by a user by selecting an appropriate body material 28. An appropriate body material is closed-cell plastic foam, such as Polylam® or PolyPlank® LAM laminated polyethylene foam, which may be the same closed-cell plastic foam selected for the hook engaging portion 18 and the rod holder engaging portion 12. As shown by FIG. 2, the shelf body 22, the hook engaging portion 18 and the rod holder engaging portion 12 may be formed of a single species of closed-cell plastic foam. The shelf body 22, the hook engaging portion 18 and the rod holder engaging portion 12 may be formed from a unitary or composite piece of the selected species of plastic foam, such as the Polylam® or PolyPlank® LAM laminated polyethylene foam.

As shown by FIGS. 2 and 3, the shelf body defines a depression 30. The depression retains loose objects on the shelf, such as bait to be placed on a hook.

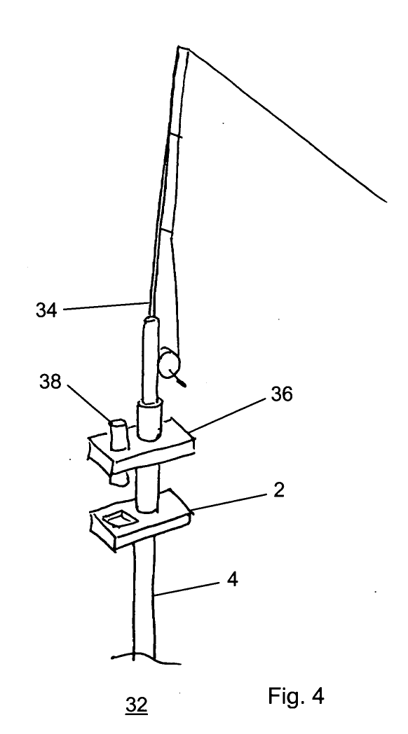

FIG. 4 illustrates the shelf 2 of the Invention in operation. In FIG. 4, shelf 2 is in place on a cylindrical fishing rod holder 4, in this case a sand spike. The fishing rod holder 4 is driven into a beach 32 to secure the fishing rod holder 4 in an upright position. A handle of fishing rod 34 is inserted into the fishing rod holder 4. In the example illustrated by FIG. 4, a second shelf 36 is installed above shelf 2. Second shelf 36 has been configured by the user by cutting a hole to receive flashlight 38 for night fishing. The flashlight 38 retained by second shelf 36 illuminates shelf 2.

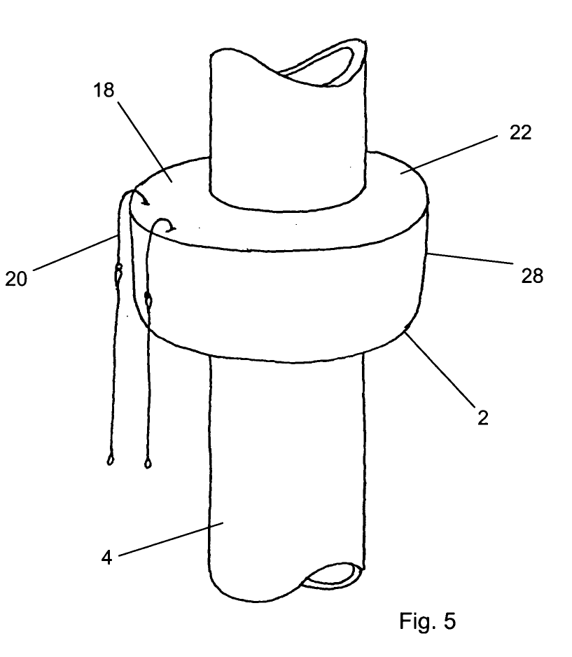

FIG. 5 illustrates an alternative embodiment. In the alternative embodiment illustrated by FIG. 5, shelf 2 is adapted to store fish hooks 20 and related tackle. The shelf 2 dispenses with depression 30, shown by FIGS. 2 and 3. The shelf 2 of the alternative embodiment shown by FIG. 5 has a body material 28 composed of closed-cell plastic foam and releasably engages the cylindrical fishing rod holder 4.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. A shelf apparatus for use with a fishing rod holder, the apparatus comprising: a shelf body, said shelf body being adapted to releasably engage the fishing rod holder, the fishing rod holder being cylindrical.

2. The apparatus of claim 1 wherein said adaptation of said shelf body to releasably engage the fishing rod holder comprising: a rod holder engaging portion defined by said shelf body, said rod holder engaging portion defining an opening, said opening having an inside diameter, the fishing rod holder having an outside diameter, said inside diameter of said opening being less than said outside diameter of the fishing rod holder.

3. The apparatus of claim 2 wherein said adaptation of said shelf body to releasably engage the fishing rod holder further comprising: said rod holder engaging portion being composed of a rod holder engaging portion material, said rod holder engaging portion material being selected to elastically deform in response to an insertion of said fishing rod holder through said opening, said rod holder engaging portion material having a rod holder engaging portion stiffness, said rod holder engaging portion stiffness being selected to releasably retain said shelf body on the fishing rod holder when the fishing rod holder is inserted through said opening.

4. The apparatus of claim 3 wherein said holder engaging portion material is a closed-cell plastic foam.

5. The apparatus of claim 4 further comprising: a hook-engaging portion defined by said shelf body, said hook-engaging portion being adapted to releasably receive a fish hook.

6. The apparatus of claim 5 wherein said adaptation of said hook-engaging portion to releasably receive a fish hook comprising: said hook-engaging portion being composed of a hook-engaging portion material, said hook engaging portion material being selected to tolerate a repeated puncture of said hook-engaging portion by said fish hook, said hook-engaging material portion material being further selected to not trap a barb of said hook.

7. The apparatus of claim 6 wherein said hook-engaging portion material is said closed-cell plastic foam.

8. The apparatus of claim 7 wherein said shelf body is adapted to be readily configured by a user.

9. The apparatus of claim 8 wherein said adaptation of said shelf body to be readily configured by said user comprises: said shelf body being composed of a body material, said body material being selected so that said shelf body may be readily cut by said user.

10. The apparatus of claim 9 wherein said body material has a body material stiffness, said body material stiffness being selected such that said shelf body will support a fishing tackle without substantial deformation when said shelf body is engaging the fishing rod holder.

11. The apparatus of claim 10 wherein said body material is said closed-cell foam.

12. The apparatus of claim 11 wherein said closed cell foam is selected from the group consisting of polyethylene foam and polypropylene foam.

13. A shelf apparatus for use with a cylindrical fishing rod holder, the apparatus comprising:
a. a shelf body;
b. an opening defined by and penetrating through said shelf body, said opening having an inside diameter, the cylindrical fishing rod holder having an outside diameter, said inside diameter of said opening being less than said outside diameter of the cylindrical fishing rod holder.

14. The shelf apparatus of claim 13 wherein said shelf body is adapted to be readily configured by a user and wherein said body is adapted to store a fishing hook.

15. The shelf apparatus of claim 14 wherein said adaptation of said body to be readily configured by said user and said adaptation of said body to store a fishing hook comprises: said body being composed of a closed-cell plastic foam, said foam being selected to securely and releasably engage said fishing hook and further being selected to be readily cut by said user.

16. The apparatus of claim 15 wherein said closed-cell foam is selected from a list consisting of polyethylene foam and polyurethane foam.

17. The apparatus of claim 16 wherein said shelf body defines a depression.

18. The apparatus of claim 17 wherein said closed-cell foam is a laminated polyethylene foam.

19. A shelf apparatus for use with a cylindrical fishing rod holder, the apparatus comprising:
a. a shelf body composed of a laminated polyethylene foam, said laminated polyethylene foam being selected such that said shelf body may be configured readily by a user;
b. an opening defined by and extending through said shelf body, said shelf body being adapted to releasably engage the cylindrical fishing rod holder.

20. The apparatus of claim 19 wherein said adaptation of said shelf body to releasably engage said cylindrical fishing rod holder comprising: said opening having an inside diameter, the cylindrical fishing rod holder having an outside diameter, said inside diameter of said opening being less than said outside diameter of the cylindrical fishing rod holder, said laminated polyethylene foam and said inside diameter of said opening being selected to allow the shelf apparatus to releasably engage the cylindrical fishing rod holder.

21. The apparatus of claim 20 wherein said laminated polyethylene foam is selected such that the shelf apparatus readily accepts and readily releases a point of a hook penetrating said shelf body.

22. The apparatus of claim 21 further comprising: a depression defined by said shelf body.
